(19) United States
(12) Patent Application Publication
(10) Pub. No.: US 2026/0105003 A1
(43) Pub. Date: Apr. 16, 2026

(54) CACHING METHOD AND APPARATUS OF UNIVERSAL FLASH STORAGE

(71) Applicant: SAMSUNG ELECTRONICS CO., LTD., Suwon-si (KR)

(72) Inventors: Ting ZHANG, XiAn (CN); Sizhe XIONG, XiAn (CN); Weibang LIU, XiAn (CN); Sung-Jun PARK, XiAn (CN)

(73) Assignee: SAMSUNG ELECTRONICS CO., LTD., Suwon-si (KR)

(21) Appl. No.: 19/201,576

(22) Filed: May 7, 2025

(30) Foreign Application Priority Data
Oct. 12, 2024 (CN) 202411422629.5

(51) Int. Cl. G06F 12/0802

(52) U.S. Cl. CPC G06F 12/0802; G06F 2212/7203

(57) ABSTRACT

There provides a caching method and apparatus of a universal flash storage (UFS). The caching method of the UFS includes: acquiring at least one current storage information of the UFS including a single level cell (SLC) buffer and a multi-level cell at predetermined interval, wherein the multi-level cell includes at least two levels of cells; acquiring input data of a neural network based on the at least one current storage information; acquiring adjustment information of the SLC buffer via the neural network based on the input data; and adjusting a size of the SLC buffer based on the adjustment information of the SLC buffer.

### CROSS-REFERENCE TO RELATED APPLICATION

This U.S. non-provisional application claims priority under 35 USC § 119 to Chinese Patent Application No. 202411422629.5, filed on Oct. 12, 2024, in the Chinese National Intellectual Property Administration, the disclosure of which is herein incorporated by reference in its entirety.

### BACKGROUND

### 1. Field

The present disclosure relates to the field of storage. Specifically, the disclosure relates to a caching method and apparatus of a universal flash storage (UFS).

### 2. Description of Related Art

Recently, caching techniques such as Turbo Write have been generally employed in a UFS. The existing Turbo Write technique is mainly divided into the static Turbo Write and the dynamic Turbo Write. In a UFS employing the static Turbo Write, a size of a single level cell (SLC) buffer remains constant during operation. This technique writes all data at a host terminal into the SLC buffer, and then flushes the data in the SLC buffer into a multi-layer cell such as a Triple Level Cell (TLC), a Quad Level Cell (QLC), and the like. In a UFS employing the dynamic Turbo Write, the size of the SLC buffer is adjusted in real time according to an adjustment factor during operation, that is, the size of the SLC buffer may be increased when an overall available storage capacity becomes large, and the size of the SLC buffer may be reduced when the overall available storage capacity becomes small.

However, according to the static Turbo Write, the size of the SLC buffer is fixed, and all data sent from the host terminal will be written to the SLC buffer first, resulting in a significant increase in the amount of erasing in the SLC buffer, thereby reducing the lifetime of the SLC buffer; in addition, when the SLC buffer is fully written, subsequent data will be written to e.g. the TLC, the QLC, etc., resulting in a rapid decline in writing performance and a deterioration in user experience. On the other hand, according to the dynamic Turbo Write, when the overall available storage capacity is smaller, the SLC buffer is adjusted to be smaller, and after the SLC buffer is fully written, subsequent data is written to e.g. the TLC, the QLC, etc., and the writing performance declines sharply. Moreover, when the overall available storage capacity is larger, the SLC buffer is adjusted to be larger, but the overall storage capacity is reduced, the storage utilization rate is not high, and the device cannot achieve optimal performance.

### SUMMARY

According to one or more example embodiments, a caching method of a universal flash storage (UFS), may include: acquiring current storage information of the UFS, wherein the UFS includes a single level cell (SLC) buffer and a multi-level cell at predetermined interval, the multi-level cell includes at least two levels of cells, and the current storage information includes a first parameter and a second parameter; applying a first weight to the first parameter and a second weight to the second parameter to generate weighted current storage information; acquiring input data of a neural network based on the weighted current storage information; acquiring adjustment information of the SLC buffer via the neural network based on the input data; and adjusting a size of the SLC buffer based on the adjustment information of the SLC buffer.

The first parameter and the second parameter may include at least one of: current storage of the UFS, current storage of the SLC buffer, or current workload of the UFS.

The acquiring the input data of the neural network based on the current storage information may include: acquiring the input data of the neural network based on the first parameter and the second parameter, at least one overall storage information of the UFS respectively corresponding to the first parameter and the second parameter, and the first weight and the second weight.

The neural network may be a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.

According to one or more example embodiments, a caching apparatus of a universal flash storage (UFS), may include: a storage information acquiring unit configured to acquire current storage information of the UFS, wherein the UFS includes a single level cell (SLC) buffer and a multi-level cell at predetermined interval, the multi-level cell includes at least two levels of cells, and the current storage information includes a first parameter and a second parameter; an input data acquiring unit configured to: apply a first weight to the first parameter and a second weight to the second parameter to generate weighted current storage information; and acquire input data of a neural network based on the weighted current storage information; an adjustment information acquiring unit configured to acquire adjustment information of the SLC buffer via the neural network based on the input data; and an adjusting unit configured to adjust a size of the SLC buffer based on the adjustment information of the SLC buffer.

The first parameter and the second parameter may include at least one of: current storage of the UFS, current storage of the SLC buffer, or current workload of the UFS.

The input data acquiring unit may be further configured to: acquire the input data of the neural network based on the first parameter and the second parameter, at least one overall storage information of the UFS respectively corresponding to the first parameter and the second parameter, and the first weight and the second weight.

The neural network may be a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.

According to one or more example embodiments, a non-transitory computer-readable medium having stored thereon computer executable instructions that, when executed, may execute the method.

According to one or more example embodiments, a caching apparatus of a universal flash storage (UFS), may include: at least one processor; and memory storing instructions that, when executed by the at least one processor, cause the at least one processor to: acquire current storage information of the UFS, wherein the UFS includes a single level cell (SLC) buffer and a multi-level cell at predetermined interval, the multi-level cell includes at least two levels of cells, and the current storage information includes a first parameter and a second parameter; apply a first weight to the first parameter and a second weight to the second parameter to generate weighted current storage information; acquire input data of a neural network based on the weighted current storage information; acquire adjustment information of the SLC buffer via the neural network based on the input data; and adjust a size of the SLC buffer based on the adjustment information of the SLC buffer.

The first parameter and the second parameter may include at least one of: current storage of the UFS, current storage of the SLC buffer, or current workload of the UFS.

The instructions may further cause the at least one processor to: acquire the input data of the neural network based on the first parameter and the second parameter, at least one overall storage information of the UFS respectively corresponding to the first parameter and the second parameter, and the first weight and the second weight.

The neural network may be a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.

### BRIEF DESCRIPTION OF THE DRAWINGS

The above and other destinations and features will become more apparent from the following detailed descriptions, taken in conjunction with the accompanying drawings in which:

FIG. 1 is a flowchart illustrating a caching method of a UFS according to one or more embodiments of the present disclosure;

FIG. 2 is a schematic diagram illustrating a Mobilenet_V3 according to one or more embodiments of the present disclosure;

FIG. 3 is a block diagram illustrating a caching apparatus of a UFS according to one or more embodiments of the present disclosure;

FIG. 4 is a schematic diagram illustrating a system to which a storage device is applied according to one or more embodiments of the present disclosure;

FIG. 5 is a block diagram illustrating a host storage system according to one or more embodiments of the present disclosure; and

FIG. 6 is a diagram illustrating a data center to which a storage device is applied according to one or more embodiments of the present disclosure.

### DETAILED DESCRIPTION

Hereinafter, various example embodiments of the present disclosure are described with reference to the accompanying drawings, in which the same reference numerals are used to depict the same or similar elements, features, and structures. However, the present disclosure is not intended to be limited by the various example embodiments described herein to a specific embodiment and it is intended that the present disclosure covers all modifications, equivalents, and/or alternatives of the present disclosure, provided they come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following descriptions of various example embodiments of the present disclosure are provided for illustration purpose only and not for the purpose of limiting the present disclosure as defined by the appended claims and their equivalents.

It is to be understood that the singular forms include plural forms, unless the context clearly indicates otherwise. The terms “include”, “contain”, and “have”, used herein, indicate functions, operations, or the existence of elements of the disclosure, but do not exclude other functions, operations, or elements.

For example, the expressions “A or B”, or “at least one of A and/or B” may indicate A and B, and A or B. For example, the expression “A or B” or “at least one of A and/or B” may indicate (1) A, (2) B, or (3) both A and B.

In various example embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various example embodiments of the present disclosure, may be used interchangeably with expressions such as “suitable for”, “having the capacity to . . . ”, “designed to”, “adapted to”, “made to”, and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain example embodiments of the present in addition, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding the example embodiments of the present disclosure.

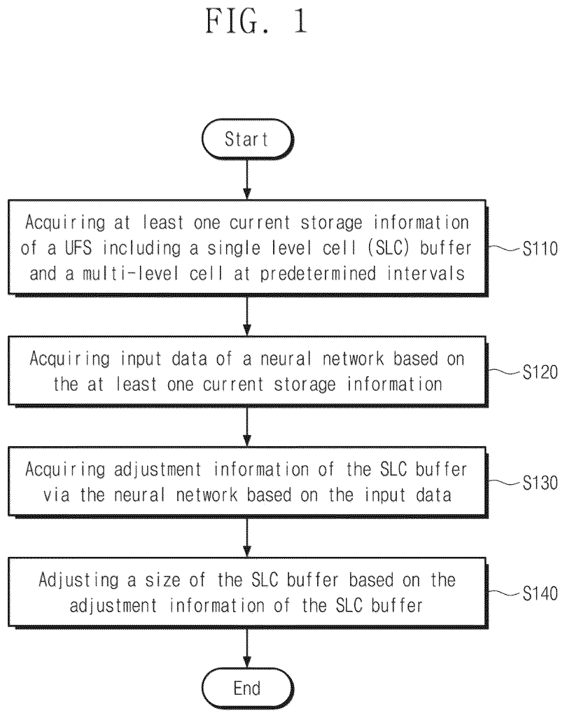

FIG. 1 is a flowchart illustrating a caching method of a UFS according to one or more embodiments of the present disclosure. According to the example embodiment of the present disclosure, the UFS may be a UFS employing dynamic Turbo Write, but the present disclosure is not limited thereto, for example, the UFS may be a UFS including a single level cell (SLC) buffer and a multi-level cell (which may include at least two levels of cells, such as, the multi-level cell may include a TLC, a QLC, etc.) as described below employing any caching technique.

Referring to FIG. 1, in step S110, at least one current storage information of the UFS including a single level cell (SLC) buffer and a multi-level cell may be acquired at predetermined interval, wherein the multi-level cell includes at least two levels of cells, such as, the multi-level cell may include a TLC, a QLC, etc. According to the example embodiment of the present disclosure, the predetermined interval may be 5 minutes, but the present disclosure is not limited thereto.

According to the example embodiment of the present disclosure, the at least one current storage information of the UFS may include current storage information of the UFS, current storage information of the SLC buffer and current workload information of the UFS. According to the example embodiment of the present disclosure, by performing data analysis, the current storage information of the UFS may be further determined as an available storage size of the current UFS (including SLC buffers and multi-level cells such as a TLC and a QLC) and a throughput of a UFS (including SLC buffers and multi-level cells such as a TLC and a QLC) within a predetermined time, the current storage information of the SLC buffer may be more specifically determined as a size of the current SLC buffer, an available size of the current SLC buffer, an adjustment status of the size of the current SLC buffer and a lifetime of the current SLC buffer, and the current workload information of the UFS may be more specifically determined as an input-output (IO) write size of the UFS (including SLC buffers and multi-level cells such as a TLC and a QLC)) within a predetermined time, data heat within a predetermined time, a synchronization (here, the synchronization refers to the synchronization between a UFS and a memory of a device to which the UFS belongs, the same below) data amount (including all data, such as data, metadata and database data) within a predetermined time, a data synchronization data amount (including data only) within a predetermined time, and a database synchronization data amount (including database data only) within a predetermined time, thereby obtaining better results.

In step S120, input data of a neural network may be acquired based on the at least one current storage information. According to the example embodiment of the present disclosure, the acquiring the input data of the neural network based on the at least one current storage information may include: acquiring the input data of the neural network based on the at least one current storage information, at least one overall storage information of the UFS respectively corresponding to the at least one current storage information, and a corresponding weight. According to the example embodiment of the present disclosure, the input data of the neural network may be acquired by multiplying a ratio of the current storage information to the overall storage information of the UFS by a corresponding weight.

According to the example embodiment of the present disclosure, the input data of the neural network may be acquired via Equation 1 below based on the available storage size of the current UFS.

$$F = \frac{{S}_{UFS available}}{{S}_{UFS}} \times W 1 \qquad [ Equation 1 ]$$

where F denotes the input data, S_{UFS available} denotes the available storage size of the current UFS, S_{UFS} denotes the overall storage size of the UFS (including SLC buffers and multi-level cells such as a TLC and a QLC), and W1 denotes the weight, the value of which may be 0.435, but the present disclosure is not limited thereto.

According to the example embodiment of the present disclosure, the input data of the neural network may be acquired via Equation 2 below based on the size of the current UFS buffer.

$$F = \frac{{S}_{SLC}}{{S}_{UFS}} \times W 2 \qquad [ Equation 2 ]$$

where F denotes the input data, S_{SLC} denotes the size of the current SLC buffer, S_{UFS} denotes the overall storage size of the UFS (including SLC buffers and multi-level cells such as a TLC and a QLC), and W2 denotes the weight, the value of which may be 0.628, but the present disclosure is not limited thereto.

According to the example embodiment of the present disclosure, the input data of the neural network may be acquired via Equation 3 below based on the IO write size of the UFS within a predetermined time.

$$F = \frac{{S}_{IO write}}{{S}_{total write read}} \times W 3 \qquad [ Equation 3 ]$$

where F denotes the input data, S_{IO write} denotes the IO write size of the UFS within a predetermined time, S_{total write read} denotes a total IO read and write size of the UFS, and W3 denotes the weight, the value of which may be 0.279, but the present disclosure is not limited thereto.

One or more of the parameters used in Equations 1-3 (e.g. S_{SLC}, S_{UFS available}, S_{IO write}) may be considered a first parameter or a second parameter. Weights W1-W3 can be applied to these parameters according to Equations 1-3 by e.g. the input data acquiring unit.

The acquisition of other information is similar to that of the above information and will not be repeated here.

In addition, after multiplying the ratio of the current storage information to the overall storage information of the UFS by the corresponding weight, a data augmentation method may be applied to the acquired data, such as one-dimensional data, to acquire input data suitable for inputting to the neural network. For example, the data augmentation method may be applied to the acquired one-dimensional data to obtain three-dimensional data, such as the three-dimensional data of 224×224×3 to be suitable for the neural network such as a Mobilenet_V3, but the present disclosure is not limited thereto.

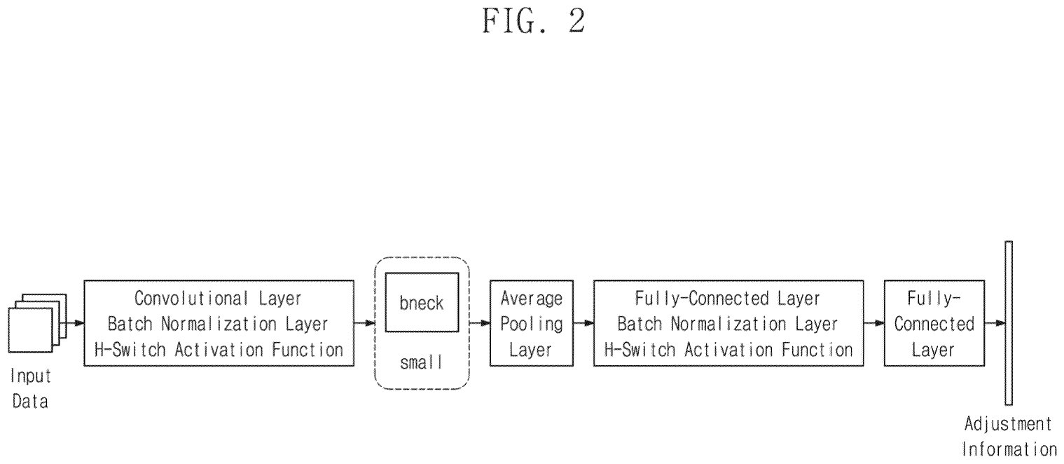

In step S130, the adjustment information of the SLC buffer may be acquired via the neural network based on the input data. According to the example embodiment of the present disclosure, the neural network may be the Mobilenet_V3. FIG. 2 is a schematic diagram illustrating a Mobilenet_V3 according to one or more embodiments of the present disclosure. As illustrated in FIG. 2, the number of layers of a Bneck (Bneck changes a convolution layer traditionally used to a deep separable convolution, to split an ordinary convolution into one deep convolution and one point-by-point convolution) network of the Mobilenet_V3 may be set to small (i.e. 11 layers, but the present disclosure is not limited thereto), a rectified linear unit (ReLU) activation function in the Mobilenet_V3 may be replaced with an H-switch activation function to make it more suitable for computation at a mobile terminal, and an output dimension of the Mobilenet_V3 may be modified to output a single value as the adjustment information of the SLC buffer. According to the example embodiment of the present disclosure, by modifying matrix dimensions of a fully-connected layer of the Mobilenet_V3, matrices may be enabled to be multiplied to obtain a single value as an output. According to the example embodiment of the present disclosure, the current storage information of the above UFS may be employed to train the Mobilenet_V3. It should be understood that the Mobilenet_V3 is only an example rather than a limitation of the present disclosure. The present disclosure may also employ other neural networks, such as a residual network.

In step S140, a size of the SLC buffer may be adjusted based on the adjustment information of the SLC buffer. According to the example embodiment of the present disclosure, the adjustment information of the SLC buffer may be encoded and transmitted to a driving layer of the UFS, and the driving layer may transmit the adjustment information of the SLC buffer to a device layer to adjust the size of the SLC buffer.

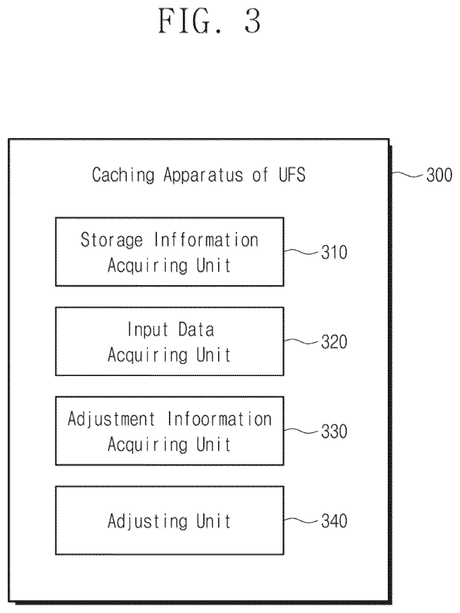

FIG. 3 is a block diagram illustrating a caching apparatus of a UFS according to one or more embodiments of the present disclosure.

Referring to FIG. 3, a caching apparatus 300 of the UFS according to the example embodiment of the present disclosure may include a storage information acquiring unit 310, an input data acquiring unit 320, an adjustment information acquiring unit 330 and an adjusting unit 340.

The storage information acquiring unit 310 may be configured to acquire at least one current storage information of the UFS including a single level cell (SLC) buffer and a multi-level cell at predetermined intervals, wherein the multi-level cell includes at least two levels of cells. According to the example embodiment of the present disclosure, the at least one current storage information of the UFS may include current storage information of the UFS, current storage information of the SLC buffer and current workload information of the UFS.

The input data acquiring unit 320 may be configured to acquire input data of a neural network based on the at least one current storage information. The input data acquiring unit 320 may further be configured to: acquire the input data of the neural network based on the at least one current storage information, at least one overall storage information of the UFS respectively corresponding to the at least one current storage information, and a corresponding weight.

The adjustment information acquiring unit 330 may be configured to acquire adjustment information of the SLC buffer via the neural network based on the input data. According to the example embodiment of the present disclosure, the neural network may be a mobile network V3 (Mobilenet_V3), the number of layers of the Bneck network of the Mobilenet_V3 may be set to small, a rectified linear unit (ReLU) activation function in the Mobilenet_V3 may be replaced with an H-switch activation function, and an output dimension of the Mobilenet_V3 may be modified to output a single value as the adjustment information of the SLC buffer.

The adjusting unit 340 may be configured to adjust a size of the SLC buffer based on the adjustment information of the SLC buffer.

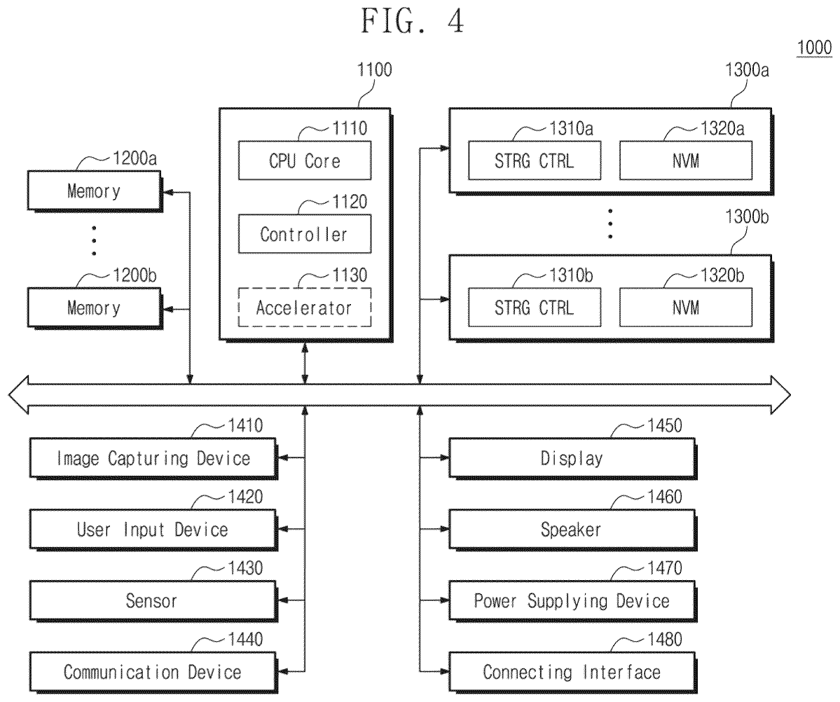

FIG. 4 is a schematic diagram illustrating a system 1000 to which a storage device is applied according to one or more embodiments of the present disclosure.

The system 1000 of FIG. 4 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 4 is not necessarily limited to the mobile system and may be a PC, a laptop computer, a server, a media player, or an automotive device (e.g., a navigation device).

Referring to FIG. 4, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The (at least one) main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 10 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, but the present disclosure is not limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

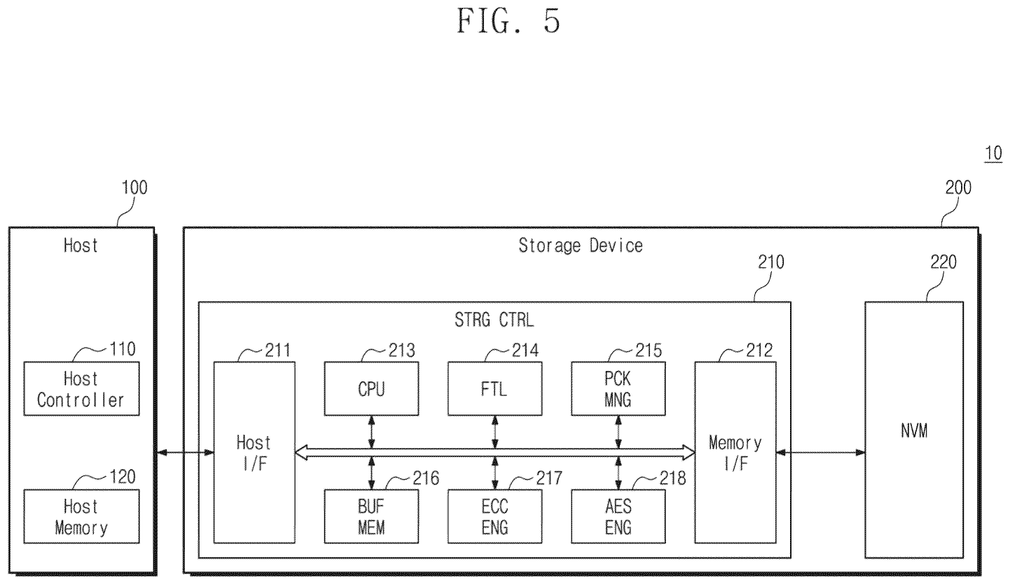

FIG. 5 is a block diagram of a host storage system 10 according to one or more embodiments of the present disclosure.

The host storage system 10 may include a host 100 and a storage device 200. Further, the storage device 200 may include a storage controller 210 and an NVM 220. According to one or more embodiments of the present disclosure, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to one or more embodiments, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

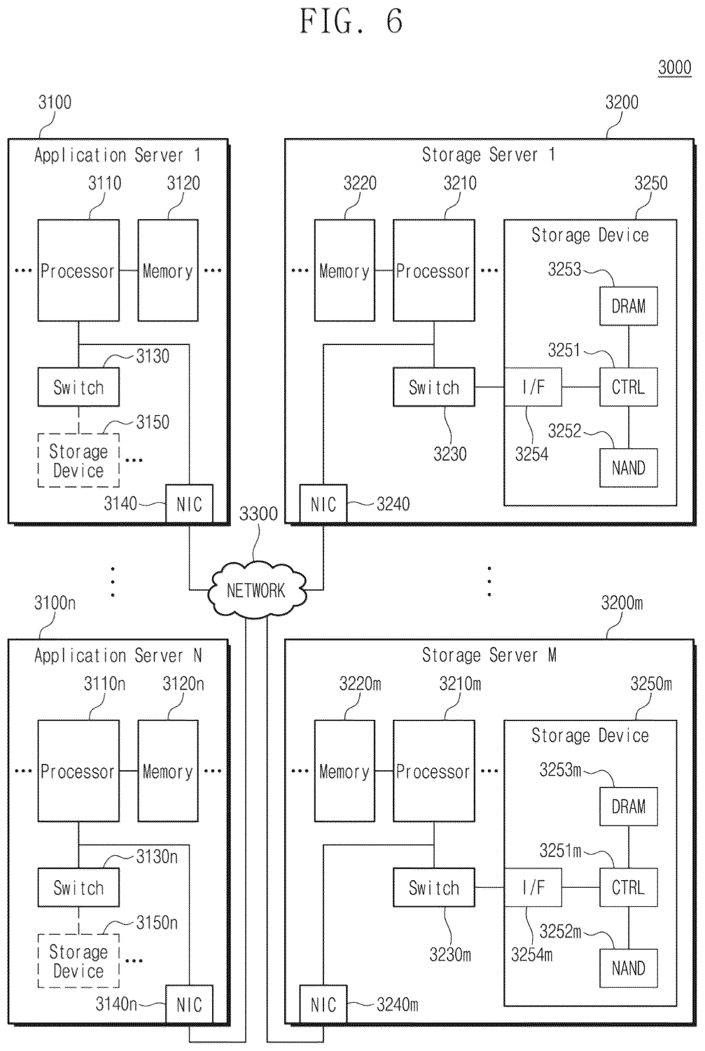

FIG. 6 is a diagram illustrating a data center 3000 to which a storage device is applied according to one or more embodiments of the present disclosure.

Referring to FIG. 6, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In one or more embodiments, the processor 3210 and the memory 3220 may provide a processor-memory pair. In one or more embodiments, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In one or more embodiments, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In one or more embodiments, the NIC 3240 may include a network interface card and a network adapter. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In one or more embodiments, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In one or more embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

One or more embodiments herein may constitute an improvement to computer functionality (i.e. improving the functioning of the computer itself) by providing a novel method of memory management. This improves computational performance and memory longevity, solving a problem in the realm of computer networks.

According to one or more embodiments of the present disclosure, there provides a non-transitory computer-readable medium having stored thereon computer executable instructions that, when executed, execute the previously mentioned method. Examples of the computer-readable medium here may include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state drive (SSD), card storage (such as, Multimedia Cards, Secure Digital (SD) Cards or Extreme Digital (XD) Cards), magnetic tapes, floppy disks, magneto-optical data storage devices, optical data storage devices, hard disks, solid state disks, and any other device. The any other device is configured to store a computer program and any relevant data, data files and data structures in a non-transitory manner and to provide the computer program and any relevant data, data files and data structures to a processor or computer, so that the processor or computer can execute the computer program. The computer program in the above computer-readable medium may run in an environment deployed in computer devices such as a client, a host, an agent device and a server. In addition, in an example, the computer program and any relevant data, data files and data structures are distributed over networked computer systems, so that the computer program and any relevant data, data files and data structures are stored, accessed and executed in a distributed manner by one or more processors or computers.

According to the example embodiments of the present disclosure, by dynamically computing and deciding the current optimal size of the SLC buffer and adjusting the same based on storage information of the UFS, the storage capacity of the device may be fully utilized to improve the overall read and write performance and storage utilization rate of the host terminal; in addition, by employing the current storage information of the UFS, the current storage information of the SLC buffer and the current workload information of the UFS to obtain the input data of the neural network of the Mobilenet_V3, and adjust and modify the network structure of the Mobilenet_V3, the read and write performance of the host terminal may be optimized, and user experience is improved effectively.

Although the present disclosure has been illustrated and described with reference to specific example embodiments, it will be understood by those skilled in the art that various changes in form and detail may be made without departing from the spirit and scope of the present disclosure as defined by the claims and the equivalents thereof.

What is claimed is:

1. A caching method of a universal flash storage (UFS), comprising:
acquiring current storage information of the UFS, wherein the UFS comprises a single level cell (SLC) buffer and a multi-level cell at predetermined interval, the multi-level cell comprises at least two levels of cells, and the current storage information comprises a first parameter and a second parameter;
applying a first weight to the first parameter and a second weight to the second parameter to generate weighted current storage information;
acquiring input data of a neural network based on the weighted current storage information;
acquiring adjustment information of the SLC buffer via the neural network based on the input data; and
adjusting a size of the SLC buffer based on the adjustment information of the SLC buffer.

2. The caching method of the UFS of claim 1, wherein the first parameter and the second parameter comprise at least one of: current storage of the UFS, current storage of the SLC buffer, or current workload of the UFS.

3. The caching method of the UFS of claim 1, wherein the acquiring the input data of the neural network based on the current storage information comprises:
acquiring the input data of the neural network based on the first parameter and the second parameter, at least one overall storage information of the UFS respectively corresponding to the first parameter and the second parameter, and the first weight and the second weight.

4. The caching method of the UFS of claim 1, wherein the neural network is a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.

5. A caching apparatus of a universal flash storage (UFS), comprising:
a storage information acquiring unit configured to acquire current storage information of the UFS, wherein the UFS comprises a single level cell (SLC) buffer and a multi-level cell at predetermined interval, the multi-level cell comprises at least two levels of cells, and the current storage information comprises a first parameter and a second parameter;
an input data acquiring unit configured to:
apply a first weight to the first parameter and a second weight to the second parameter to generate weighted current storage information; and
acquire input data of a neural network based on the weighted current storage information;
an adjustment information acquiring unit configured to acquire adjustment information of the SLC buffer via the neural network based on the input data; and
an adjusting unit configured to adjust a size of the SLC buffer based on the adjustment information of the SLC buffer.

6. The caching apparatus of the UFS of claim 5, wherein the first parameter and the second parameter comprise at least one of: current storage of the UFS, current storage of the SLC buffer, or current workload of the UFS.

7. The caching apparatus of the UFS of claim 5, wherein the input data acquiring unit is further configured to:
acquire the input data of the neural network based on the first parameter and the second parameter, at least one overall storage information of the UFS respectively corresponding to the first parameter and the second parameter, and the first weight and the second weight.

8. The caching apparatus of the UFS of claim 5, wherein the neural network is a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.

9. A caching apparatus of a universal flash storage (UFS), comprising:
at least one processor; and
memory storing instructions that, when executed by the at least one processor, cause the at least one processor to:
acquire current storage information of the UFS, wherein the UFS comprises a single level cell (SLC) buffer and a multi-level cell at predetermined interval, the multi-level cell comprises at least two levels of cells, and the current storage information comprises a first parameter and a second parameter;
apply a first weight to the first parameter and a second weight to the second parameter to generate weighted current storage information;
acquire input data of a neural network based on the weighted current storage information;
acquire adjustment information of the SLC buffer via the neural network based on the input data; and
adjust a size of the SLC buffer based on the adjustment information of the SLC buffer.

10. The caching apparatus of the UFS of claim 9, wherein the first parameter and the second parameter comprise at least one of: current storage of the UFS, current storage of the SLC buffer, or current workload of the UFS.

11. The caching apparatus of the UFS of claim 9, wherein the instructions further cause the at least one processor to:
acquire the input data of the neural network based on the first parameter and the second parameter, at least one overall storage information of the UFS respectively corresponding to the first parameter and the second parameter, and the first weight and the second weight.

12. The caching apparatus of the UFS of claim 9, wherein the neural network is a mobile network V3 (Mobilenet_V3), a number of layers of a Bneck network of the Mobilenet_V3 is set to small, a rectified linear unit (ReLU) activation function in the Mobilenet_V3 is replaced with an H-switch activation function, and an output dimension of the Mobilenet_V3 is modified to output a single value as the adjustment information of the SLC buffer.
